(19) United States
(12) Patent Application Publication
(10) Pub. No.: US 2008/0156139 A1
(43) Pub. Date: Jul. 3, 2008

(54) Grip for handlebar of bicycle

(75) Inventor: Ching-Chuan Lai, Taichung City (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: BIKEFORCE INTERNATIONAL CO., LTD., Taichung City (TW)

(21) Appl. No.: 11/648,993

(22) Filed: Jan. 3, 2007

(51) Int. Cl. B62K 21/26; B62K 21/12

(52) U.S. Cl. 74/551.9; 16/421

(57) ABSTRACT

A grip for a handlebar of a bicycle includes a rigid plastic inner shell, a soft plastic outer shell, two metallic clamps, and two locking bolts. Thus, when the metallic clamps are tightened by the locking bolts, the inner face of each of the metallic clamps presses the outer surface of the metallic handlebar completely to increase the contact area and to increase the friction, so that the grip is fixed on the metallic handlebar solidly and exactly.

### BACKGROUND OF THE INVENTION

1. Field of the Invention

The present invention relates to a grip and, more particularly, to a grip for a handlebar of a bicycle.

2. Description of the Related Art

A grip for a handlebar of a bicycle comprises a rigid plastic inner shell mounted on a handlebar of a bicycle, a soft plastic outer shell enclosed around the rigid plastic inner shell, and a clamping element to clamp the two free ends of the rigid plastic inner shell on the handlebar to prevent the rigid plastic inner shell from being rotated relative to the handlebar.

A conventional clamping element (or rigid metal clamp) for clamping a grip was disclosed in U.S. Pat. No. 6,263,759-B1, wherein the outer surface of the rigid plastic inner shell is formed with a lengthwise protrusion, and the inner surface of the clamping element is formed with a receiving recess to receive the lengthwise protrusion of the rigid plastic inner shell. Thus, when the locking bolt on the clamping element is tightened, the rigid plastic inner shell is pressed onto the handlebar by the clamping element. However, the contact area between the inner face of the clamping element and the outer face of the handlebar is reduced due to provision of the lengthwise protrusion of the rigid plastic inner shell and the receiving recess of the clamping element, thereby reducing the friction action between the clamping element and the handlebar, so that the rigid plastic inner shell is not fixed on the handlebar solidly and exactly by the clamping element.

### BRIEF SUMMARY OF THE INVENTION

In accordance with one embodiment of the present invention, there is provided a grip for a handlebar of a bicycle, comprising a hollow tubular rigid plastic inner shell having two free ends and having an inside formed with a mounting hole mounted on a handlebar and extended between the two free ends, at least one substantially C-shaped metallic clamp having a slit, two opposite end faces and an annular inner face, and at least one locking bolt locked on two opposite sidewalls of the slit of the metallic clamp to compress the metallic clamp to force the inner face of the metallic clamp to press an outer surface of the metallic handlebar completely, so that the rigid plastic inner shell is fixed on and cannot be rotated relative to the metallic handlebar. The mounting hole of the rigid plastic inner shell has two ends each having an opening which has a periphery formed with an annular end face, at least one end face of the rigid plastic inner shell is formed with at least one arc-shaped positioning protrusion extending in a circumferential direction, and a first radial width is defined between a radial inner wall of the positioning protrusion and an inner surface of the opening. One of the end faces of the metallic clamp is formed with at least one arc-shaped positioning slot extending in a circumferential direction to allow insertion of the positioning protrusion of the rigid plastic inner shell, and a second radial width is defined between a radial inner wall of the positioning slot and the inner face of the metallic clamp and is equal to the first radial width.

In accordance with another embodiment of the present invention, there is provided a grip for a handlebar of a bicycle, comprising a hollow tubular rigid plastic inner shell having two free ends and having an inside formed with a mounting hole mounted on a handlebar and extended between the two free ends, at least two arc-shaped metallic clamping blocks each having two free ends, two opposite end faces and an annular inner face, and at least two locking bolts locked on the two free ends of the at least two arc-shaped metallic clamping blocks respectively to compress the metallic clamping blocks radially toward each other to force the inner face of each of the metallic clamping blocks to press the outer surface of the metallic handlebar completely, so that the rigid plastic inner shell is fixed on and cannot be rotated relative to the metallic handlebar. The mounting hole of the rigid plastic inner shell has two ends each having an opening which has a periphery formed with an annular end face, at least one end face of the rigid plastic inner shell is formed with at least one arc-shaped positioning protrusion extending in a circumferential direction, and a first radial width is defined between a radial inner wall of the positioning protrusion and an inner surface of the opening. One of the end faces of at least one of the metallic clamping blocks is formed with at least one arc-shaped positioning slot extending in a circumferential direction to allow insertion of a respective positioning protrusion of the rigid plastic inner shell, and a second radial width is defined between a radial inner wall of the positioning slot and the inner face of the metallic clamp and is equal to the first radial width.

The primary objective of the present invention is to provide a grip, wherein when the metallic clamps are tightened by the locking bolts, the inner face of each of the metallic clamps presses the outer surface of the metallic handlebar completely to increase the contact area and to increase the friction, so that the grip is fixed on the metallic handlebar solidly and exactly.

Another objective of the present invention is to provide a grip, wherein each of the metallic clamps can clamp the metallic handlebar by a metal-to-metal friction action, thereby enhancing the combination strength between the grip and the metallic handlebar.

A further objective of the present invention is to provide a grip, wherein the positioning protrusion of the rigid plastic inner shell is inserted into the positioning slot of each of the metallic clamps, so that the rigid plastic inner shell is retained by each of the metallic clamps to prevent the rigid plastic inner shell from being rotated relative to the metallic handlebar.

A further objective of the present invention is to provide a grip, wherein the positioning slot is not extended through each of the metallic clamps, so that the positioning protrusion of the rigid plastic inner shell is fully hidden in the positioning slot of each of the metallic clamps, thereby enhancing the outer appearance of the grip.

A further objective of the present invention is to provide a grip, wherein the size, number and specification of the positioning protrusion and the positioning slot can be changed according to the practical requirement, thereby enhancing the versatility of the grip.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a grip in accordance with the first preferred embodiment of the present invention.

FIG. 2 is an exploded perspective view of the grip as shown in FIG. 1.

FIG. 3 is a partially side view of the grip as shown in FIG. 1.

FIG. 4 is a side view of a metallic clamp of the grip as shown in FIG. 1.

FIG. 5 is a side cross-sectional view of the grip as shown in FIG. 1.

FIG. 6 is a perspective view showing the grip for a handlebar of a bicycle in accordance with the first preferred embodiment of the present invention.

FIG. 7 is a front cross-sectional view of the grip for the handlebar as shown in FIG. 6.

FIG. 8 is a side cross-sectional view of the grip for the handlebar as shown in FIG. 6.

FIG. 9 is a side cross-sectional view of a grip for a handlebar of a bicycle in accordance with the second preferred embodiment of the present invention.

FIG. 10 is a side cross-sectional view of a grip for a handlebar of a bicycle in accordance with the third preferred embodiment of the present invention.

FIG. 11 is an exploded perspective view of a grip in accordance with the fourth preferred embodiment of the present invention.

FIG. 12 is a side cross-sectional assembly view of the grip for a handlebar of a bicycle in accordance with the fourth preferred embodiment of the present invention.

### DETAILED DESCRIPTION OF THE INVENTION

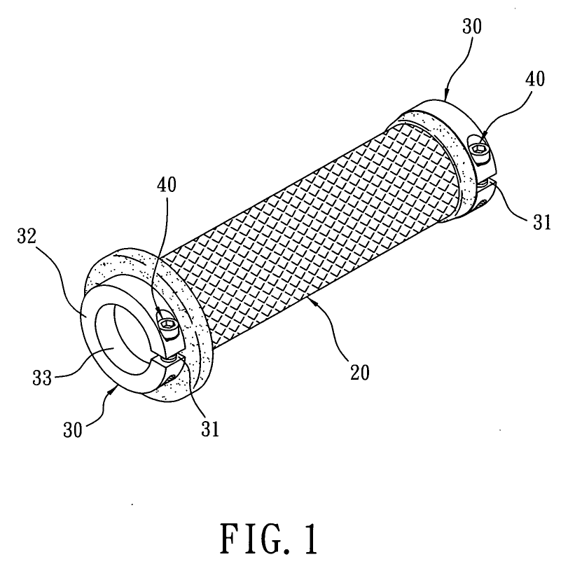

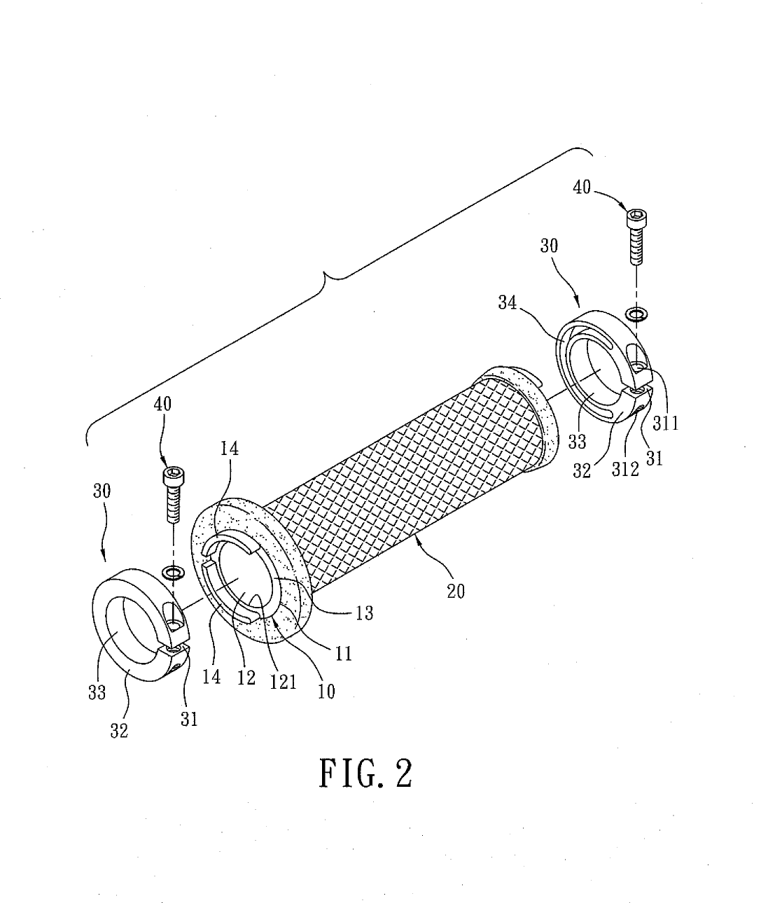

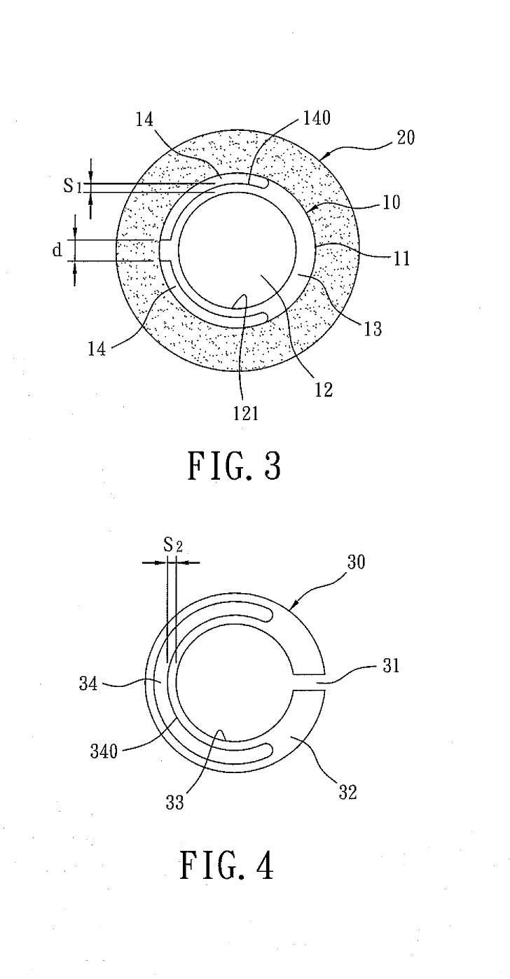

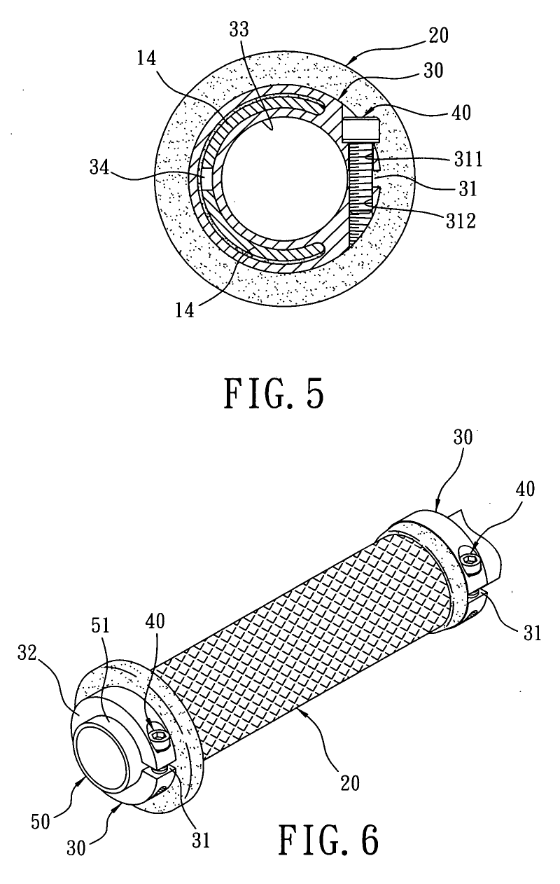

Referring to the drawings and initially to FIGS. 1-5, a grip for a handlebar of a bicycle in accordance with the first preferred embodiment of the present invention comprises a rigid plastic inner shell 10, a soft plastic outer shell 20, two metallic clamps 30, and two locking bolts 40.

The rigid plastic inner shell 10 is made of a rigid plastic material and has a hollow tubular shape. The rigid plastic inner shell 10 has two free ends 11 and has an inside formed with a mounting hole 12 mounted on a metallic handlebar 50 (see FIG. 6) of a bicycle and extended between the two free ends 11. The mounting hole 12 of the rigid plastic inner shell 10 has two ends each having a circular opening 121 which has a periphery formed with an annular end face 13. In the preferred embodiment of the present invention, the end face 13 of the rigid plastic inner shell 10 is formed with two spaced arc-shaped positioning protrusions 14 each extending in a circumferential direction. Thus, a distance “d” is defined between the positioning protrusions 14, and a first radial width “S1” is defined between a radial inner wall of each of the positioning protrusions 14 and an inner surface of the circular opening 121.

The soft plastic outer shell 20 is made of a soft plastic material and is integrally enclosed around an outer surface of the rigid plastic inner shell 10 to facilitate a rider holding the grip.

Each of the metallic clamps 30 is substantially C-shaped and has a slit 31, two opposite end faces 32 and an annular inner face 33. The slit 31 of each of the metallic clamps 30 has a first sidewall formed with a through hole 311 and a second sidewall formed with a screw bore 312 facing the through hole 311. One of the end faces 32 of each of the metallic clamps 30 is formed with an arc-shaped positioning slot 34 extending in a circumferential direction and facing a respective end face 13 of the rigid plastic inner shell 10 to allow insertion of a respective positioning protrusion 14 of the rigid plastic inner shell 10. A second radial width “S2” is defined between a radial inner wall of the positioning slot 34 and the inner face 33 of each of the metallic clamps 30 and is equal to the first radial width “S1”. In the preferred embodiment of the present invention, a gap is defined between the positioning slot 34 of each of the metallic clamps 30 and the respective positioning protrusion 14 of the rigid plastic inner shell 10 to facilitate insertion of the respective positioning protrusion 14 of the rigid plastic inner shell 10 into the positioning slot 34 of each of the metallic clamps 30.

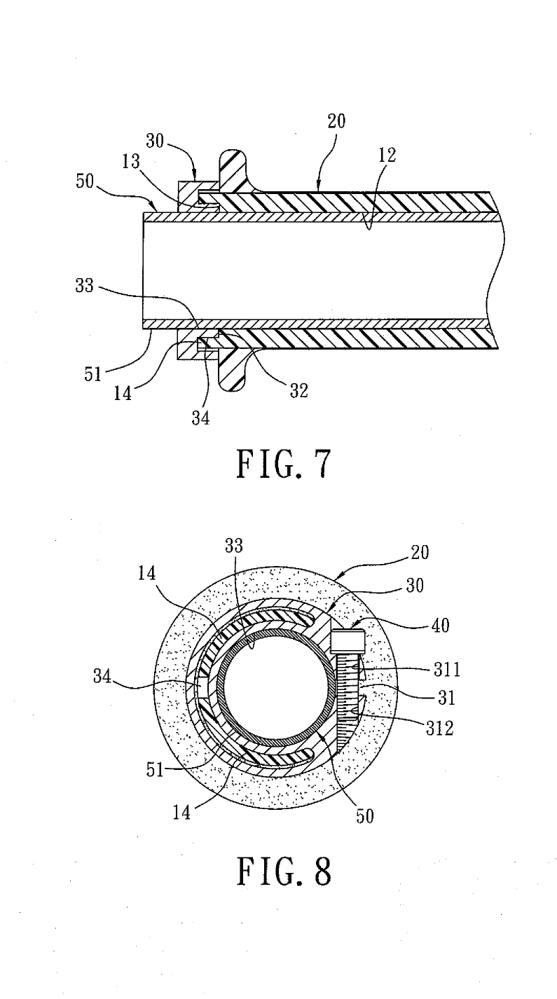

Referring to FIGS. 1-8, each of the locking bolts 40 is extended through the through hole 311 of a respective metallic clamp 30 and screwed into the screw bore 312 of the respective metallic clamp 30 to compress the respective metallic clamp 30 radially and inwardly to force the inner face 33 of the respective metallic clamp 30 to press an outer surface 51 of the metallic handlebar 50 completely as shown in FIGS. 6-8, so that the rigid plastic inner shell 10 is fixed on and cannot be rotated relative to the metallic handlebar 50.

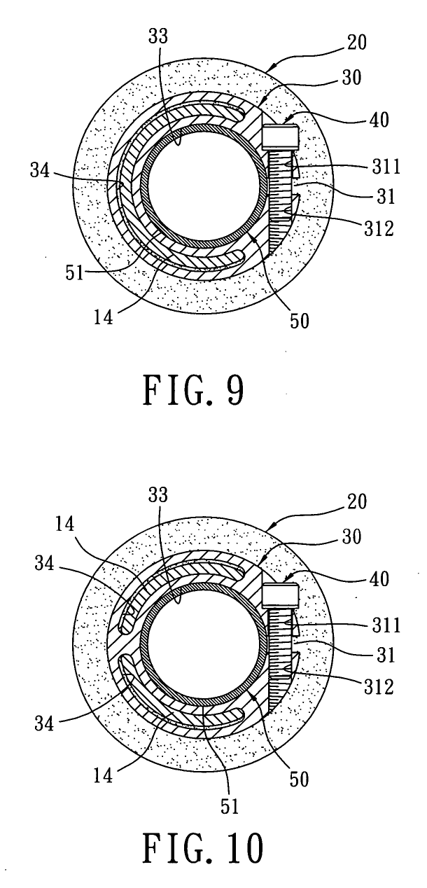

As shown in FIG. 9, the grip in accordance with the second preferred embodiment of the present invention is similar to that of the first preferred embodiment of the present invention, and the difference is in that the end face 13 of the rigid plastic inner shell 10 is formed with a single arc-shaped positioning protrusion 14 inserted into the positioning slot 34 of the respective metallic clamp 30.

As shown in FIG. 10, the grip in accordance with the third preferred embodiment of the present invention is similar to that of the first preferred embodiment of the present invention, and the difference is in that one of the end faces 32 of each of the metallic clamps 30 is formed with two spaced arc-shaped positioning slots 34 to allow insertion of the respective positioning protrusions 14 of the rigid plastic inner shell 10.

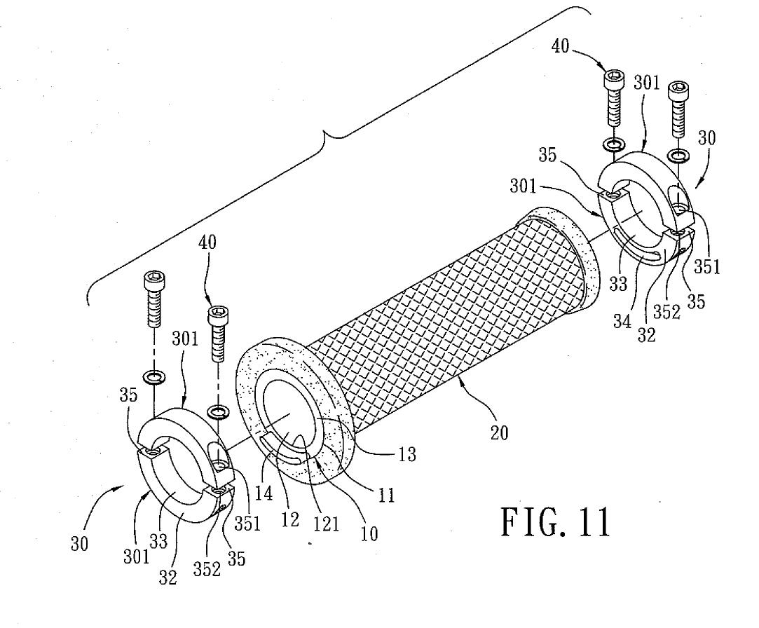

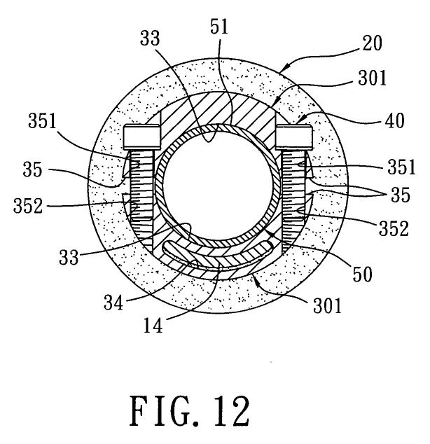

As shown in FIGS. 11 and 12, the grip in accordance with the fourth preferred embodiment of the present invention is similar to that of the first preferred embodiment of the present invention, and the difference is in that each of the metallic clamps 30 includes two arc-shaped metallic clamping blocks 301 each having two opposite end faces 32 and an annular inner face 33. Each of the metallic clamping blocks 301 has two free ends 35, wherein each of the free ends 35 of one of the metallic clamping blocks 301 is formed with a through hole 351, and each of the free ends 35 of the other one of the metallic clamping blocks 301 is formed with a screw bore 352. In addition, one of the end faces 32 of at least one of the metallic clamping blocks 301 is formed with an arc-shaped positioning slot 34 to allow insertion of a respective positioning protrusion 14 of the rigid plastic inner shell 10.

In assembly, each of the locking bolts 40 is extended through the through hole 351 of one of the metallic clamping blocks 301 and screwed into the screw bore 352 of the other one of the metallic clamping blocks 301 to compress the metallic clamping blocks 301 radially toward each other to force the inner face 33 of each of the metallic clamping blocks 301 to press the outer surface 51 of the metallic handlebar 50 completely as shown in FIG. 12, so that the rigid plastic inner shell 10 is fixed on and cannot be rotated relative to the metallic handlebar 50.

Accordingly, a first radial width “S1” is defined between the radial inner wall of each of the positioning protrusions 14 and the inner surface of the circular opening 121, and a second radial width “S2” is defined between the radial inner wall of the positioning slot 34 and the inner face 33 of each of the metallic clamps 30 (or the metallic clamping blocks 301) and is equal to the first radial width “S1”, so that each of the positioning protrusions 14 is spaced from the inner surface of the circular opening 121, and the positioning slot 34 is spaced from the inner face 33 of each of the metallic clamps 30 (or the metallic clamping blocks 301). Thus, when the metallic clamps 30 (or the metallic clamping blocks 301) are tightened by the locking bolts 40, the inner face 33 of each of the metallic clamps 30 (or the metallic clamping blocks 301) presses the outer surface 51 of the metallic handlebar 50 completely to increase the contact area and to increase the friction, so that the grip is fixed on the metallic handlebar 50 solidly and exactly. In addition, each of the metallic clamps 30 (or the metallic clamping blocks 301) clamps the metallic handlebar 50 by a metal-to-metal friction action, thereby enhancing the combination strength between the grip and the metallic handlebar 50. Further, the positioning protrusion 14 of the rigid plastic inner shell 10 is inserted into the positioning slot 34 of each of the metallic clamps 30 (or the metallic clamping blocks 301), so that the rigid plastic inner shell 10 is retained by each of the metallic clamps 30 (or the metallic clamping blocks 301) to prevent the rigid plastic inner shell 10 from being rotated relative to the metallic handlebar 50. Further, the positioning slot 34 is not extended through each of the metallic clamps 30 (or the metallic clamping blocks 301), so that the positioning protrusion 14 of the rigid plastic inner shell 10 is fully hidden in the positioning slot 34 of each of the metallic clamps 30 (or the metallic clamping blocks 301), thereby enhancing the outer appearance of the grip. Further, the size, number and specification of the positioning protrusion 14 and the positioning slot 34 can be changed according to the practical requirement, thereby enhancing the versatility of the grip.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A grip, comprising:
a hollow tubular rigid plastic inner shell having two free ends and having an inside formed with a mounting hole mounted on a handlebar and extended between the two free ends, wherein the mounting hole of the rigid plastic inner shell has two ends each having an opening which has a periphery formed with an annular end face, at least one end face of the rigid plastic inner shell is formed with two spaced arc-shaped positioning protrusions extending in a circumferential direction, and a first radial width is defined between a radial inner wall of each of the positioning protrusions and an inner surface of the opening;
at least one substantially C-shaped metallic clamp mounted on the handlebar and having a slit, two opposite end faces and an annular inner face, wherein one of the end faces of the metallic clamp is formed with an arc-shaped positioning slot extending in a circumferential direction to allow insertion of the two positioning protrusions of the rigid plastic inner shell, and a second radial width is defined between a radial inner wall of the positioning slot and the inner face of the metallic clamp and is equal to the first radial width;
at least one locking bolt locked on two opposite sidewalls of the slit of the metallic clamp to compress the metallic clamp to force the inner face of the metallic clamp to press an outer surface of the handlebar completely, so that the rigid plastic inner shell is fixed on and cannot be rotated relative to the handlebar; wherein
the second radial width is greater than zero so that the positioning slot is isolated from the inner face of the metallic clamp and is not in contact with the outer surface of the handlebar, and the inner face of the metallic clamp has a continuous circumferential length to contact and press the outer surface of the handlebar completely and to increase a contact area between the metallic clamp and the handlebar.

2. The grip in accordance with claim 1, wherein the end face of the rigid plastic inner shell is formed with a positioning protrusion, and one of the end faces of the metallic clamp is formed with a positioning slot to allow insertion of the positioning protrusion of the rigid plastic inner shell.

3. (canceled)

4. The grip in accordance with claim 1, wherein the end face of the rigid plastic inner shell is formed with two spaced positioning protrusions, and one of the end faces of the metallic clamp is formed with two spaced positioning slots to allow insertion of the two positioning protrusions of the rigid plastic inner shell respectively.

5. The grip in accordance with claim 1, further comprising a soft plastic outer shell enclosed around an outer surface of the rigid plastic inner shell to facilitate a rider holding the grip.

6. The grip in accordance with claim 1, wherein the slit of the metallic clamp has a first sidewall formed with a through hole and a second sidewall formed with a screw bore facing the through hole, and the locking bolt is extended through the through hole of the metallic clamp and screwed into the screw bore of the metallic clamp.

7. A grip, comprising:
a hollow tubular rigid plastic inner shell having two free ends and having an inside formed with a mounting hole mounted on a handlebar and extended between the two free ends, wherein the mounting hole of the rigid plastic inner shell has two ends each having an opening which has a periphery formed with an annular end face, at least one end face of the rigid plastic inner shell is formed with at least one arc-shaped positioning protrusion extending in a circumferential direction, and a first radial width is defined between a radial inner wall of the positioning protrusion and an inner surface of the opening;
at least two arc-shaped metallic clamping blocks each having two free ends, two opposite end faces and an annular inner face, wherein one of the end faces of at least one of the metallic clamping blocks is formed with at least one arc-shaped positioning slot extending in a circumferential direction to allow insertion of a respective positioning protrusion of the rigid plastic inner shell, and a second radial width is defined between a radial inner wall of the positioning slot and the inner face of the metallic clamp and is equal to the first radial width;
at least two locking bolts locked on the two free ends of the at least two arc-shaped metallic clamping blocks respectively to compress the metallic clamping blocks radially toward each other to force the inner face of each of the metallic clamping blocks to press the outer surface of the handlebar completely, so that the rigid plastic inner shell is fixed on and cannot be rotated relative to the handlebar.

8. The grip in accordance with claim 7, wherein the end face of the rigid plastic inner shell is formed with a positioning protrusion, and one of the end faces of one of the metallic clamping blocks is formed with a positioning slot to allow insertion of the positioning protrusion of the rigid plastic inner shell.

9. The grip in accordance with claim 7, wherein the end face of the rigid plastic inner shell is formed with two spaced positioning protrusions, and one of the end faces of each of the metallic clamping blocks is formed with a positioning slot to allow insertion of the respective positioning protrusion of the rigid plastic inner shell.

10. The grip in accordance with claim 7, further comprising a soft plastic outer shell enclosed around an outer surface of the rigid plastic inner shell to facilitate a rider holding the grip.

11. The grip in accordance with claim 7, wherein each of the free ends of one of the metallic clamping blocks is formed with a through hole, each of the free ends of the other one of the metallic clamping blocks is formed with a screw bore, and each of the locking bolts is extended through the through hole of one of the metallic clamping blocks and screwed into the screw bore of the other one of the metallic clamping blocks.

12. The grip in accordance with claim 1, wherein the first radial width is greater than 1 mm (millimeter).

13. The grip in accordance with claim 1, wherein the first radial width is greater than zero so that each of the positioning protrusions of the rigid plastic inner shell is spaced from the inner surface of the circular opening of the rigid plastic inner shell and is not in contact with the outer surface of the handlebar, and the inner surface of the circular opening of the rigid plastic inner shell has a continuous circumferential length to contact and press the outer surface of the handlebar completely and to increase a contact area between the rigid plastic inner shell and the handlebar.

14. The grip in accordance with claim 1, wherein the two positioning protrusions of the rigid plastic inner shell are contiguous to form a substantially C-shaped profile.
